(19) United States
(12) Patent Application Publication
(10) Pub. No.: US 2010/0161713 A1
(43) Pub. Date: Jun. 24, 2010

(54) METHOD AND SYSTEM FOR PERSONALIZING A DESKTOP WIDGET

(75) Inventors: Kiran Gangadharappa, Mountain View, CA (US); Apurv R. Jawle, Fremont, CA (US); Vincent Mendicino, Burlingame, CA (US); Andrew Ng, Fremont, CA (US); Neil Srivatsan, Santa Clara, CA (US); Dirk Wodtke, Soquel, CA (US)

Correspondence Address: SCHWEGMAN, LUNDBERG & WOESSNER/SAP, P.O. BOX 2938, MINNEAPOLIS, MN, 55402, US

(73) Assignee: SAP AGDIETMAR-HOPP-ALLEE

(21) Appl. No.: 12/338,861

(22) Filed: Dec. 18, 2008

(51) Int. Cl. G06F 3/048; G06F 15/16

(52) U.S. Cl. 709/203; 715/765

(57) ABSTRACT

A system to personalize a widget is provided. An example system to provide a system to personalize a widget comprises a personalization trigger to detect a personalization request to configure a desktop widget available at a client computer system to alter complexity of data rendered by the desktop widget; a screen definition module to determine a personalized screen definition, based on configuration parameters associated with the personalization request; and a screen definition module to provide the personalized screen definition and the associated application data to the client computer system, the personalized screen definition reflecting the altered complexity of data to be rendered by the desktop widget.

### TECHNICAL FIELD

This application relates to the field of widgets and specifically to a method and system for personalizing a desktop widget.

### BACKGROUND

Widgets are mini-applications adapted to allow a user to monitor or interact with certain information provided by a server computer system. Widgets may be described as interactive virtual tools that provide single-purpose services by pulling data from a backend system and presenting this data on the user's display device. Examples of widgets include computer programs such as alarm clocks, local weather information monitors, stock monitors, etc. For example, in a sales company, the Operations Department senior management and analysts may be responsible for carefully tracking the revenue, inventory and open order status in real time. The monitoring is particularly important during the last week of each month. A revenue tracking widget may be utilized in this situation to provide a user with on demand access to up-to-date relevant information, which may reduce or even eliminate the tasks of manually retrieving information numerous times throughout the day and manually extracting one or two key data points in each report.

A widget may be run on an application platform referred to as a widget engine. A widget engine may use, e.g., a JavaScript™ runtime environment combined with an Extensible Markup Language (XML) interpreter and may require that a widget is developed according to the requirement of the specific widget engine. Examples of widget engines are Yahoo!® Widgets and Vista™ Sidebar. Yahoo!® Widgets is capable of running widgets using a Java™ Script runtime environment and an XML interpreter.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example system to personalize a desktop widget may be implemented;

FIG. 2 is block diagram of a system to personalize a desktop widget, in accordance with one example embodiment;

FIG. 3 is a flow chart of a method to personalize a desktop widget, in accordance with an example embodiment;

FIG. 4 is a flow chart of a method to load a personalized desktop widget, in accordance with an example embodiment;

FIG. 5 is an example user interface illustrating a default version and a personalized version of a CSS Monitor widget, in accordance with an example embodiment;

FIG. 6 is an example user interface illustrating a personalized version of a CSS Monitor widget presenting visualized application data, in accordance with an example embodiment;

FIG. 7 is block diagram of a system for widgetizing a web-based application, in accordance with one example embodiment;

FIG. 8 is a flow chart of a method for widgetizing a web-based application, in accordance with an example embodiment;

FIG. 9 is an example user interface illustrating a request to widgetize a CSS Monitor application to a user's desktop, in accordance with an example embodiment; and

FIG. 10 is a diagrammatic representation of an example machine in the form of a computer system within which a set of instructions, for causing the machine to perform any one or more of the methodologies discussed herein, may be executed.

### DETAILED DESCRIPTION

In one example embodiment, a method and system may be provided to permit a user to configure a desktop widget to customize the appearance and the content presented by the desktop widget, such that the information rendered by the desktop widget satisfies configuration criteria selected by the user, e.g., in order to reduce complexity of data displayed by the desktop widget. For example, a “Purchase Requests” desktop widget may initially present a purchase requests table organized by request number. The table may include, in addition to the request number, product ID, product description and product category, quantity, delivery date, and other information. The user may determine that she does not wish to view request numbers or product category and configure the desktop widget to not display this information. The table displayed by thus configured “Purchase Requests” desktop widget would not include “Request number” or “Product category” columns.

On one hand, a desktop widget that has been personalized to reduce data complexity may occupy less space on a user's display screen. On the other hand, the amount of data that the server provides to the desktop widget engine in order to display purchase requests data may be reduced, which may result in reducing network traffic between the client computer system hosting the desktop widget and the server computer system that provides data to the desktop widget. The process of configuring a desktop widget to customize the appearance and the content presented by the desktop widget may be referred to as the process of widget personalization or simply personalization.

The configuration information specified by the user in the user's personalization request, also referred to as personalization information, may be stored in the user's profile. The user's profile, in turn, may be stored at the client system that hosts the desktop widget, at the server system that hosts the associated source computer application, or at any other location that may be accessible by the widget engine intended to run the associated desktop widget (the “Purchase Requests” desktop widget in this example).

Some examples of personalization that may be achieved by utilizing the techniques described herein include hiding unwanted controls and visualizing application data. For example, a user may configure a desktop widget to display, e.g., a pie chart based on the current application data provided by the source computer application, in addition to displaying the current application data in a tabular format. Because visualization of application data may be achieved by using components provided with a widget engine, a desktop widget may be configured to visualize application data even where the associated source computer application does not include visualization capability. In one example embodiment, a widget engine may be built using Adobe® AIR™, so that Flex Charting components may be engaged for visualizing application data. Adobe® AIR™ is a cross-operating system runtime that allows development of rich Internet applications using HyperText Markup Language (HTML)/Ajax, Flex, or Flash and to deploy these applications to the desktop. Adobe® AIR™ applications support native desktop integration, including clipboard and drag-and-drop support, local file input/output (I/O), system notification, etc.

In one example embodiment, a widget may be created utilizing a method and system to convert a web-based computer application that was designed without specifically complying with requirements of any particular widget engine (or a portion of such application) into a module that can be exposed to a desktop widget engine and utilized by a user as a desktop widget. A process of automatically creating a desktop widget that corresponds to a web-based application or its feature may be referred to as a process of widgetizing. While one approach to creating desktop widgets is to develop an application that conforms to the requirements to a particular widget engine, an example method and system for widgetizing a web-based application may be used to access an existing computer application that have been created without having a widget in mind as a source and expose the existing application through a generic mechanism to a widget engine in a way that the exposed application is recognized and treated by the widget engine the same way as a widget created specifically for use with that widget engine. An example approach of widgetizing a source computer application that was originally developed in a programming language that is not specific to a widget engine may shield application developers from the specifics of particular widget engines and may permit the source computer applications to be developed in a manner independent of any proprietary widget engine offerings.

In one example embodiment, a source computer application may be developed in a platform-independent language, such as Java™, and include a deployment option that indicates whether the source computer application may be externalized as a widget. The source computer application may be configured to permit a user to access its features through a web portal and to request that the application is widgetized by converting it into a widget. When a request to widgetize a source computer application is received by the backend (e.g., at a Java™ application server) from a client computer system, a component associated with the source computer application (e.g., a Java™ wrapper designed to accommodate operations needed for widgetizing, which thus may be referred to as a widgetizer) generates a so-called definition file and downloads it to the client computer system. The definition file contains a reference link to the source computer application running on the application server. The widget engine may use information that is present in the definition file to connect to the application server that hosts the source computer application The reference link may have configuration parameters directing the source computer application to produce XML or Extensible Business Client Markup Language (xBCML) output that includes screen definitions, as well as data and events information that is consumed by the widget engine in order to permit the source computer application to run as a desktop widget. For example, the widget engine built using Adobe®—Adobe® AIR™—may be configured to render xBCML as Flex/Flash controls that are characterized by having rich look and feel. Adobe® Flex is a collection of technologies released by Adobe® Systems for the development and deployment of cross-platform rich Internet applications based on the proprietary Adobe® Flash platform.

Using a concrete example, a business application running, e.g., on a Java™ application server, may produce HTML output that can be provided to a client computer and rendered by a web browser application (or simply browser) hosted by the client computer. A user accessing the business application via the browser may utilize thus presented user interface to request that a particular component of the business application is converted into a widget. For example, a user may wish to convert into a widget a “Sales Monitor” component of a business application, because a “Sales Monitor” widget would present sales data in a rich format and periodically update the presented data without the need to invoke a web browser application or the need to manually request the updated information. In one embodiment, the user may activate a “Widgetize” control, which may be implemented as a browser plug-in, to cause a request to be sent to the server hosting the business application. The server, in response, engages the business application determines a definition file associated with the “Sales Monitor,” and downloads it to the requesting client system. The definition file is then stored on the client, and the user may activate the newly created widget and be able to access up-to-date sales information without navigating a web portal associated with the business application or searching the bookmarks. A generic communication mechanism between the backend and the widget engine installed on the client computer system obtains business application data (sales data in this example) from the business application and feeds this data into the widget engine. The widget engine extracts the relevant sales information and renders it in a rich format. The widgetized “Sales Monitor” has the look and feel of a native widget. From within the “Sales Monitor” widget, a user may be permitted to navigate to the web portal of the associated web-based business application. In one example embodiment, the feature of navigation from a widget to the associated web-based computer application is implemented by storing the relevant metadata along with the widget location information during the stage where a web-based application is widgetized. A widget created by the process of widgetizing described above may be personalized using the techniques described herein.

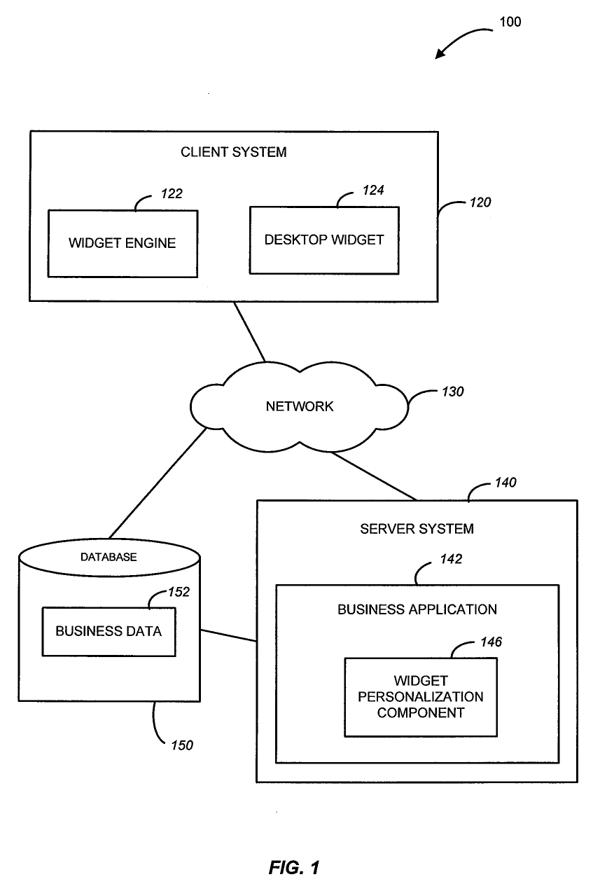

An example system to personalize a desktop widget may be implemented in the context of a network environment 100 illustrated in FIG. 1. As shown in FIG. 1, the network environment 100 may include a client computer system 120 and a server computer system 140. The client computer system 120 is shown as hosting a desktop widget 124 and a widget engine 122 capable of running the desktop widget 122. The server system 140, in one example embodiment, may host a business application 144, which, in turn, may be part of a larger computerized business platform. The business application 144, in this example, is a source computer application with respect to the desktop widget 124. The widget engine 122 may obtain data and screen definitions needed to run the desktop widget 124 from the business application 142 hosted by the server system 140 via a communications network 130. The communications network 130 may be a public network (e.g., the Internet, a wireless network, etc.) or a private network (e.g., a local area network (LAN), a wide area network (WAN), Intranet, etc.).

As shown in FIG. 1, the server system is in communication with a database 150. The database 150 may store business data 152 that may be utilized by the business application 142 and also may be provided to the client system 120 in a format suitable for use by the widget engine 122. The business application 142, in one embodiment, is a web-based application and thus may also be capable of generating HTML output suitable for rendering by a web browser application.

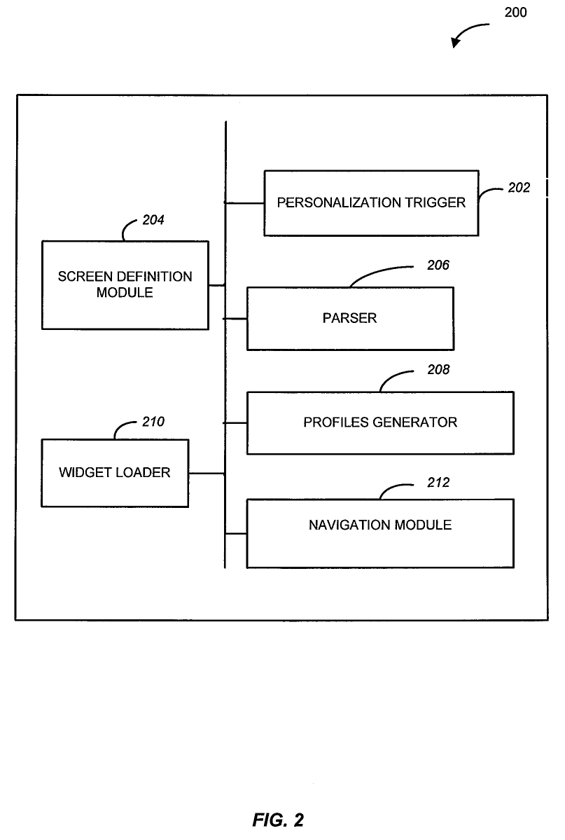

The business application 142, in one example embodiment, may be configured to include (or to cooperate with) a computer module capable of configuring the appearance and the amount of data presented by the associated desktop widget 124 at the client system 120. A computer module capable of performing this function may be referred to as a widget personalization module. A widget personalization module is identified in FIG. 1 with reference numeral 146. An example system to personalize a desktop widget is illustrated in FIG. 2.

FIG. 2 is a block diagram of a system 200 for personalizing a desktop widget, in accordance with one example embodiment. As shown in Figure 2, the system 200 includes a personalization trigger 202, a screen definition module 204, a parser 206, and a profiles generator 208. The personalization trigger, in one example embodiment, may be configured to detect a personalization request to configure the desktop widget 124 available at the client computer system 120 in order to alter complexity of data being rendered by the desktop widget 124. The screen definition module 204 may be configured to determine a personalized screen definition, based on configuration parameters associated with the personalization request. The screen definition module 204 may cooperate with the parser 206, where the parser 206 parses the personalization request and provides the determined personalization parameters to the screen definition module 204. The screen definition module 204 may provide the personalized screen definition and the associated application data associated with the business application 142 to the client computer system 120. The personalized screen definition reflects the altered complexity of data to be rendered by the desktop widget 124. The profiles generator 208 may be configured to determine a user associated with the personalization request and generate a profile for the user. The generated profile may reflect the altered complexity of data to be rendered by the desktop widget 124. The generated user's profile is stored at a location accessible to the widget engine 122, e.g., at the client system 120 or at the server system 140.

The system 200 may further include a widget loader 210. In one example embodiment, the widget loader 210 may be configured to receive, from the client system 120, a request to load the desktop widget 124 and, in response, instantiate the widget engine 122 (if the widget engine 122 has not yet been instantiated) and establish a communication channel between the widget engine 122 and the associated source computer application (the business application 142 in this example). The widget loader 210 may also be configured to communicate to the widget engine 122 that the desktop widget 124 is to be loaded according to the associated profile that may reflect the altered complexity of data to be rendered by the widget engine 122. In some embodiments, the altering of the complexity of the data to be rendered by the widget engine 122 may reflect reduced complexity of data, increased complexity of data, or visualizing the data, e.g., by presenting the data in a graphical form.

Also shown in FIG. 2 is a navigation module 212. The navigation module 212 may be configured to detect a navigation request from the widget engine 122 indicating that a user wishes to access the business application 142 associated with the desktop widget 124 as a web-based application. The navigation module may be responsible for instantiating a web browser at the client system 120 in response to the navigation request (if a web browser has not yet been instantiated) and to provide a web page associated with the web portal of the source computer application associated with the desktop widget 124 to the web browser.

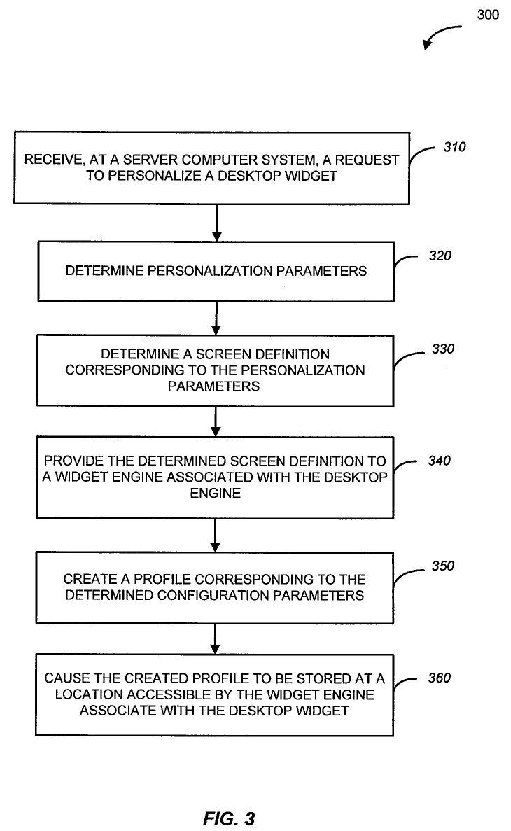

It will be noted, that embodiments may be provided where some modules of the system 200 shown as separate components are implemented as a single module. Conversely, embodiments may be provided where a component that is shown in FIG. 2 as a single module may be implemented as two or more components. Example operations performed by the system 200 in order to process personalization requests may be described with reference to FIG. 3.

FIG. 3 is a flow chart of a method 300 to personalize a desktop widget, in accordance with an example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system for personalizing a web based computer application shown in FIG. 2.

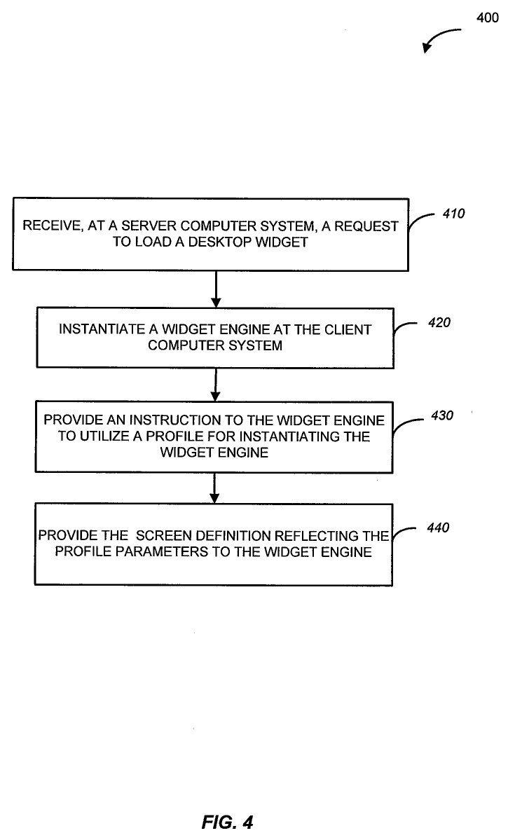

As shown in FIG. 3, the method 300 commences at operation 310, where the personalization trigger 202 of FIG. 2 detects a personalization request associated with the desktop widget 124 of FIG. 1. The parser 204 parses the request to determine configuration parameters (also referred to as personalization parameters) at operation 320 and passes the determined parameters to the screen definition module 206. At operation 330, the definitions module 206 determines a screen definition for the desktop widget 124 that reflect a personalized version of the desktop widget 124. At operation 340, the screen definition that reflects the personalized version of the desktop widget 124 is provided to the widget engine 122 of FIG. 1 responsible for running the desktop widget 124. The profiles generator 208 of FIG. 2, at operation 350, determines a user associated with the personalization request and generates a profile for the user, the profile reflecting personalization parameters provided with the personalization request. The profile is then stored at a location accessible to the widget engine at operation 360. The stored profile is to be utilized the next time the user loads the desktop widget 124. Example operations performed during the loading of the desktop widget 124 after personalization may be described with reference to FIG. 4.

FIG. 4 is a flow chart of a method 400 to load a personalized desktop widget, in accordance with an example embodiment. The method 3400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system for personalizing a web based computer application shown in FIG. 2.

As shown in FIG. 4, the method 400 commences at operation 410, where the widget loader 210 of FIG. 2 receives a request from the client system 120 to load the desktop widget 124. At operation 420, the widget loader 210 causes the widget engine 122 of FIG. 2 to be instantiated at the client system 120 and instructs the widget engine 122 to consult the user's profile prior to instantiating the desktop widget 124 at operation 430. The widget engine 126 may then instantiate the desktop widget 124 in a manner that reflects personalization parameters stored in the user's profile. The screen definitions reflecting parameters in the user's profile are provided to the widget engine 122 at operation 440.

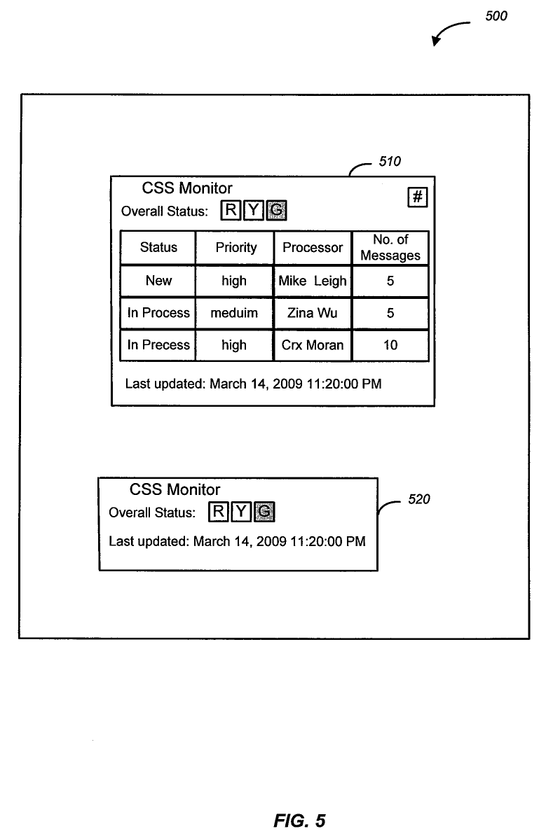

FIG. 5 is a user interface 500 illustrating a default version 510 of a Customer Service (CSS) Monitor widget and a personalized version 520 of the CSS Monitor widget, in accordance with an example embodiment. As shown in FIG. 5, the default version 510 of a CSS Monitor widget includes customer service data presented in a table that reflects status and priority of each customer service request, the names of processors assigned to handle respective requests, as well as the number of messages being handled by each processor. The personalized version 520 displays only the overall status information and information indicating when the data presented by the desktop widget was last updated. Thus, in some embodiments, the amount of data obtained from the associated source computer application running at a server computer system may be reduced when the desktop widget has been personalized. As mentioned above, a desktop widget may be personalized to cause the desktop widget to display a visualized version of application data.

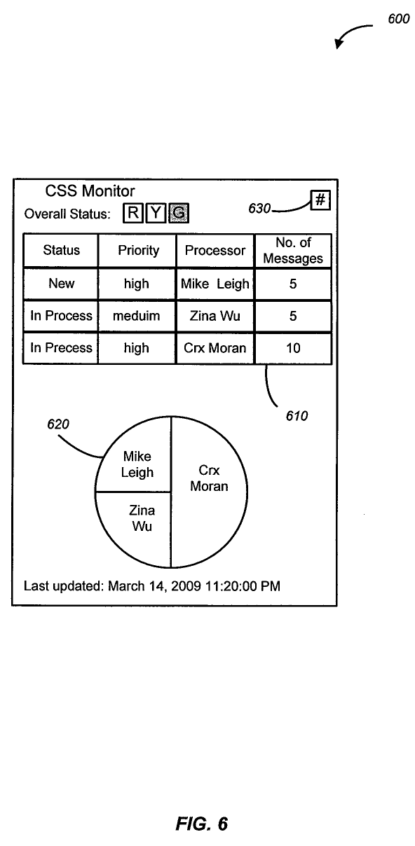

FIG. 6 is an example user interface 600 illustrating a personalized version of a CSS Monitor widget presenting visualized application data, in accordance with an example embodiment. As shown in FIG. 6, data presented in the “Number of messages” column of the displayed table 610, is visualized in a form of a pie chart 620. A user of the CSS monitor may navigate to a web-based version of the associated source computer application running at the server system by clicking on a navigation icon 630. When the navigation icon 630 is engaged, the associated source computer application receives the navigation request, instantiates a web browser at the client computer system associated with the CSS monitor widget, and provides to the web browser a web page associated with the CSS Monitor application.

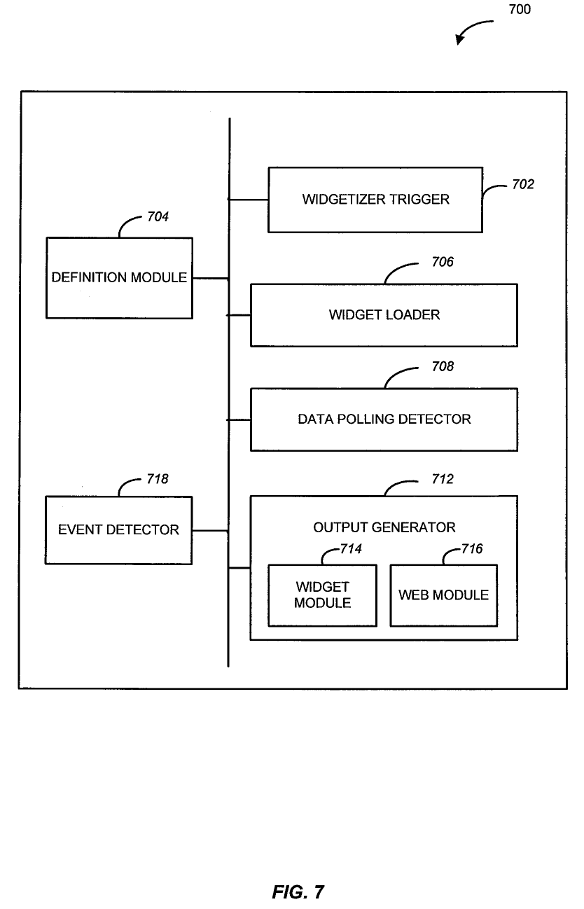

As mentioned above, a desktop widget, such as the CSS Monitor widget, may be created by converting a web based computer application into a desktop widget by the process of widgetizing. Some modules of an example web based application that includes a module configured to convert a web based application into a desktop widget (referred to as a widgetizer) may be described with reference to FIG. 7.

FIG. 7 is a block diagram of a system 700 for widgetizing a web-based application, in accordance with one example embodiment. The system 700 includes modules provided or cooperating with the business application 122 of FIG. 1. A combination of some of these modules, such as modules that trigger the process of widgetizing or generating a definitions file may be referred to collectively as a widgetizer. It will be noted, that while FIGS. 1 and 2 refer to a business application and business data, the techniques described herein to permit the use of a web-based application as a desktop widget may be utilized beneficially with web-based applications that serve purposes other than providing business data.

As shown in FIG. 7, the system 700 includes a widgetizer trigger 702 and a definition module 704. The widgetizer trigger may be configured to detect a request to widgetize a web based computer application. This request may originate from a browser application running on the client system 120 of FIG. 1 and may be issued by engaging an associated wigetizer plug-in or by activating a pre-determined control from as associated web page. The definition module 704 may be configured to determine a definition file that may be used at the client computer system 120 to facilitate access to the business application 142 (that may also be referred to as the source computer application) hosted at the server system 140 by the widget engine 122. The definition module 704 may create a definition file for the source computer application or, if the definition file has already been provided, access the definition file and send it to the client system 120. A definition file, in one example embodiment, may include a reference link to the source computer application, as well an one or more parameters. The definition file is sent to the client system 120, stored at a location accessible to the widget engine 122, and may be used by the widget engine 122 to poll the source computer application for data.

The system 700 may also include, as shown in FIG. 7, a widget loader 706, a data polling detector 708, and an output generator 712. The widget loader 706 may be configured to detect a request from the client system 120 to load the widget created as a result of widgetizing the business application 142. In response to such request, the widget loader 706 may cause the widget engine 122 to be instantiated at the client system 120, after which the widget engine 122 may use the definition file to access the business application 142 and obtain screen definitions and data to be presented by the desktop widget running on the client system 120. The data polling detector 708 may be configured to detect a request for data from the widget engine 122. The output generator 712 may be configured to respond to requests for data from the client by generating the output in a format according to the request. For example, a request for data from the widget engine 122 may include a widget indicator, directing the source computer application to generate output in a format suitable for processing by the widget engine 122. The output generator 712, in one example embodiment, may also be capable of generating HTML output, e.g., in response to a request associated with a web indicator. The output generator 712 may include a widget module 714 to detect a widget indicator and a web module 716 to detect a web indicator.

Another module of the system 2700 shown in FIG. 7 is an event detector 718. The event detector 718 may be configured to receive events from the widget engine 122. In response to the receiving of the event, the event detector 718 may update the state of the source computer application.

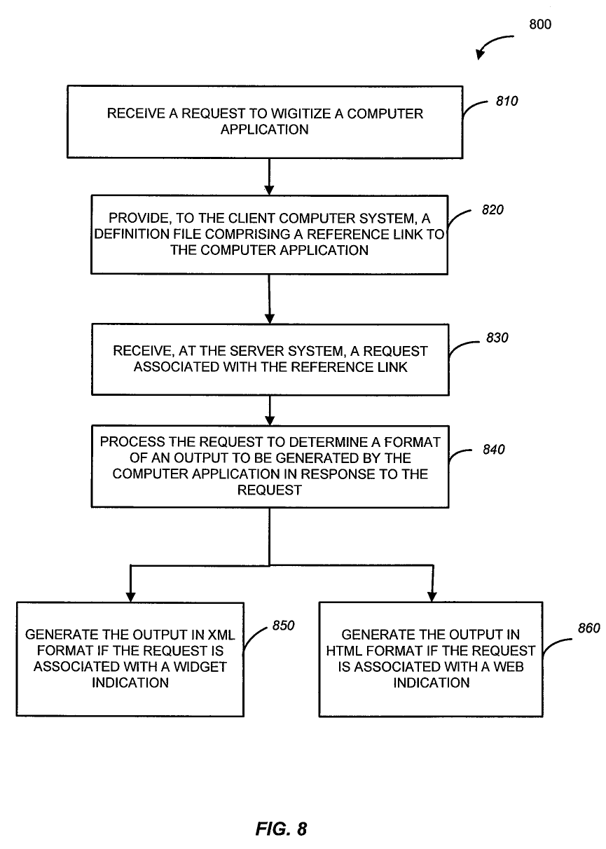

It will be noted, that embodiments may be provided where some modules of the system 700 shown as separate components are implemented as a single module. Conversely, embodiments may be provided where a component that is shown in FIG. 7 as a single module may be implemented as two or more components. Example operations performed by the system for widgetizing a web-based computer application may be described with reference to FIG. 8.

FIG. 8 is a flow chart of a method 800 to widgetize a web-based computer application, according to one example embodiment. The method 800 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system for widgetizing a web based computer application shown in FIG. 7.

As shown in FIG. 8, the method 800 commences at operation 810, where the widgetizer trigger 702 of FIG. 7 receives, from the client computer system 120 of FIG. 1, a request to widgetize a computer application (e.g., the business application 142). At operation 820, the definition module 704 of FIG. 2 determines a definition file associated with the business application 142 and provides it to the client computer system 120 for use by the widget engine 122. As mentioned above, the definition file includes a reference link associated with the business application 142 and one or more parameters. At operation 830, the data polling detector 708 of FIG. 7 receives, from the widget engine 122, a request for data associated with the reference link included in the definition file. The request for data is processed, e.g., by a parser that may be provided with the system 700 of FIG. 7, to determine a format of an output to be generated by the business application 142 in response to the request for data. At operation 850, the output is generated in XML or xBCML format (assuming the widget engine 122 is built using Adobe® AIR™) in response to determining that the request for data is associated with a widget indication. If the request for data is associated with a web indication, the output is generated in HTML format, at operation 860.

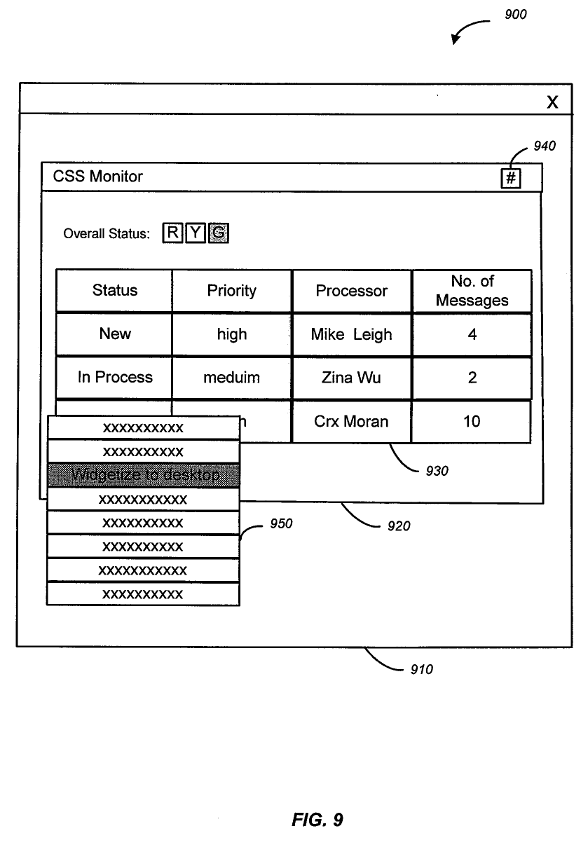

FIG. 9 is an example user interface 900 illustrating a request to widgetize a CSS Monitor application to a user's desktop, in accordance with an example embodiment. In FIG. 9, area 910 represents a web browser window, displaying a CSS monitor web page 920. The CSS Monitor web page 920 displays a table 930 that shows customer service requests data, as well as an overall status indicator in the upper right corner of the web page 920. A request to widgetize CSS Monitor may be triggered by clicking on the “Convert to widget” icon 940 or, if a widgetizer plug-in has been installed at the browser application, by invoking application context menu 950 and selecting an appropriate option.

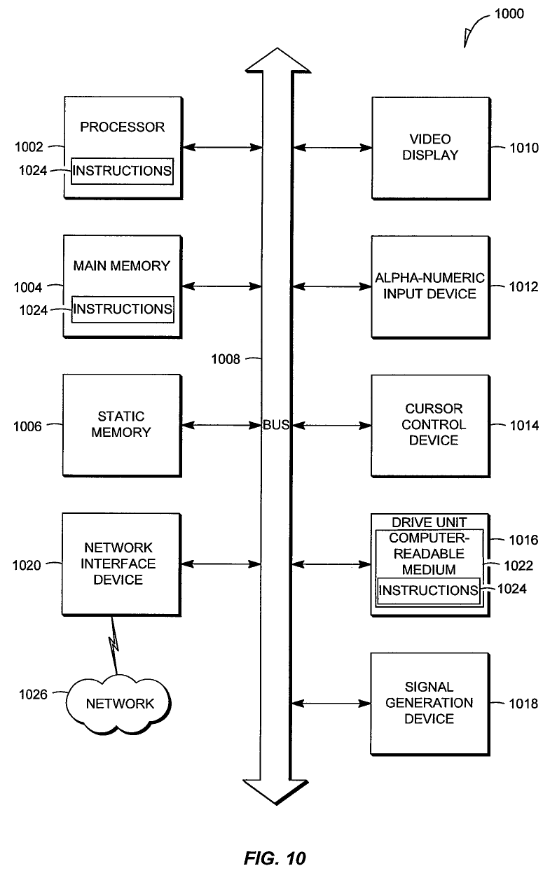

FIG. 10 shows a diagrammatic representation of a machine in the example form of a computer system 1000 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alpha-numeric input device 1012 (e.g., a keyboard), a user interface (UI) navigation device 1014 (e.g., a cursor control device), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, with the main memory 1004 and the processor 1002 also constituting machine-readable media.

The software 1024 may further be transmitted or received over a network 1026 via the network interface device 1020 utilizing any one of a number of well-known transfer protocols (e.g., Hyper Text Transfer Protocol (HTTP)).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a system to personalize a desktop widget has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. For example, while an embodiment has been described with reference to a business application, a system to personalize a widget may be implemented and utilized advantageously in the context of various other computer applications.

1. A computer-implemented system comprising:
a personalization trigger to detect a personalization request to configure a desktop widget available at a client computer system to alter complexity of data rendered by the desktop widget;
a screen definition module to determine a personalized screen definition, based on configuration parameters associated with the personalization request; and
a screen definition module to provide the personalized screen definition and the associated application data to the client computer system, the personalized screen definition reflecting the altered complexity of data to be rendered by the desktop widget.

2. The system of claim 1, comprising a profiles generator to:
determine a user associated with the personalization request; and
generate a profile for the user, the profile to reflect the altered complexity of data to be rendered by the desktop widget in response to the personalization request.

3. The system of claim 2, wherein the generated profile is stored at a location accessible to a widget engine hosted by the client computer system.

4. The system of claim 3, wherein the generated profile is stored at the client computer system.

5. The system of claim 3, comprising a widget loader to:
receive, at a server computer system, a request to load a desktop widget at a client computer system;
provide, to the client computer system, a request to instantiate a widget engine;
establish a communication channel between the widget engine and a computer application associated with the widget;
communicate, to the widget engine, that the desktop widget is to be loaded according to the generated profile.

6. The system of claim 2, wherein the altered complexity is reduced complexity of data rendered by the desktop widget.

7. The system of claim 6, wherein the personalization request is to reduce the number of data categories provided in a tabular format by the desktop widget.

8. The system of claim 7, wherein the personalization request is a request to cause visualized application data to be presented by the desktop engine.

9. The system of claim 1, comprising a navigation module to:
detect a navigation request, from a widget engine running on the client computer system, to navigate from the desktop widget to a web portal provided by a computer application associated with the desktop widget;
cause a web browser to be instantiated at the client computer system; and
provide a web page associated with the web portal to the web browser.

10. The system of claim 1, wherein the widget engine is built using Adobe AIR.

11. A computer-implemented method comprising:
using one or more processors to perform operations of:
receiving a personalization request to configure a desktop widget available at a client computer system to alter complexity of data rendered by the desktop widget;
determining a personalized screen definition based on configuration parameters associated with the personalization request; and
providing the personalized screen definition and the associated application data to the client computer system, the personalized screen definition reflecting the altered complexity of data to be rendered by the desktop widget.

12. The method of claim 11, comprising:
determining a user associated with the personalization request; and
generating a profile for the user, the profile to reflect the altered complexity of data to be rendered by the desktop widget in response to the personalization request.

13. The method of claim 12, comprising storing the generated profile at a location accessible to a widget engine hosted by the client computer system.

14. The method of claim 13, comprising storing the generated profile at the client computer system.

15. The method of claim 12, comprising:
receiving, at a server computer system, a request to load a desktop widget at a client computer system;
providing, to the client computer system, a request to instantiate a widget engine;
establishing a communication channel between the widget engine and a computer application associated with the widget;
communicating, to the widget engine, that the desktop widget is to be loaded according to the generated profile.

16. The method of claim 11, wherein the altered complexity is reduced complexity of data rendered by the desktop widget.

17. The method of claim 11, comprising providing, to a widget engine running on the client computer system, a screen definition suitable for use by the widget engine to present application data associated with a plurality of categories in a tabular format, wherein the personalization request is to reduce the number of data categories provided in a tabular format by the desktop widget.

18. The method of claim 11, wherein the personalization request is a request to cause visualized application data to be presented by the desktop engine.

19. The method of claim 11, comprising:
detecting a navigation request, from a widget engine running on the client computer system, to navigate from the desktop widget to a web portal provided by a computer application associated with the desktop widget;
causing a web browser to be instantiated at the client computer system; and
providing a web page associated with the web portal to the web browser.

20. A machine-readable medium having instruction data to cause a machine to:
detect a personalization request to configure a desktop widget available at a client computer system to alter complexity of data rendered by the desktop widget;
determine a personalized screen definition, based on configuration parameters associated with the personalization request; and
provide the personalized screen definition and the associated application data to the client computer system, the personalized screen definition reflecting the altered complexity of data to be rendered by the desktop widget.
